(19) United States
(12) Patent Application Publication
(10) Pub. No.: US 2014/0214656 A1
(43) Pub. Date: Jul. 31, 2014

(54) PAYMENT REQUESTS

(71) Applicant: Cardlink Services Limited, Rhodes NSW (AU)

(72) Inventors: Richard Mark Williams, Rhodes NSW (AU); Keith Robert Goding Brown, Rhodes NSW (AU)

(73) Assignee: Cardlink Services Limited, Rhodes NSW (AU)

(21) Appl. No.: 14/230,132

(22) Filed: Mar. 31, 2014

Related U.S. Application Data
(63) Continuation of application No. PCT/AU2011/001270, filed on Sep. 30, 2011.

(51) Int. Cl. G06Q 20/22

(52) U.S. Cl. CPC G06Q 20/223
USPC 705/39

(57) ABSTRACT

The present disclosure relates to computing systems that support payments between two users. When implemented as a computer, the computer facilitates P2P payment. The computer receives from a payee or a payee FI a payment request. The payment request includes a payer identifier, a payee identifier and payment information. The computer then determines a payer FI and sends the payment request to the payer FI to cause the payer FI to notify the payer of the payment request and to enable the payer to confirm the payment. The computer receives from the payer FI a payment notification for the payment and sends the payment notification to the payee FI. The payer and the payee are not required to open a new account at a third party system but funds are transferred directly from the payer FI to the payee FI.

### CROSS-REFERENCE TO RELATED APPLICATIONS

This application is a continuation of International Application No. PCT/AU2011/001270, filed on Sep. 30, 2011. The disclosure of the above application is incorporated herein by reference.

Incorporated here by reference is Australian provisional patent application No. 2011902123 entitled “Addresses in financial systems” filed on 31 May 2011. Incorporated by reference is PCT application also filed this day with the Australian Patent Office this day claiming priority from Australian provisional patent application No. 2011902123.

Incorporated here by reference is PCT application also filed with the Australian Patent Office this day entitled “Transaction document storage” with Cardlink Services Limited also identified as the applicant.

Incorporated here by reference is PCT application also filed with the Australian Patent Office this day entitled “Payment requests” with Cardlink Services Limited also identified as the applicant.

### FIELD

The disclosure concerns computing systems of financial institutions and computing systems that interact and support functions of financial institutions, including payments between two users of the system. The disclosure includes a description of methods, computer systems and software.

### BACKGROUND

The statements in this section merely provide background information related to the present disclosure and may not constitute prior art.

The availability of electronic communications has led to a large number of systems for electronic transfer of payments. These systems include point-of-sale (POS) terminals, such as credit card terminals, and online payment systems, such as PayPal.

POS terminals allow a payment from a payer to a typical merchant and the merchant needs to invest into the infrastructure of the POS terminals. Online systems operate in isolation from the banks and require users to open a new account with the online system. The users then need to transfer money between their bank account and the account with the online payment system in order to send or receive money via the online payment system.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

### SUMMARY

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

In a first aspect there is provided a computer implemented method performed by a central financial management system for facilitating a payment from a payer to a payee, the method comprising:
(a) receiving from a payee or a payee FI a payment request, the payment request including:
   a payer identifier,
   a payee identifier, and
   payment information;
(b) based on the payer identifier, automatically determining a payer FI and sending a message including the payment request to the payer FI to cause the payer FI to notify the payer of the payment request and to enable the payer to confirm payment;
(c) receiving from the payer FI a payment notification for the payment; and
(d) determining the payee FI associated with the payment notification and sending an output message including the payment notification to the payee FI.

It is an advantage that the central financial management system interacts between the two FIs and has stored information about the association of the user identifiers and the FIs. As a result, the payer and the payee are not required to open a new account at a third party system but the funds are transferred directly from the payer FI to the payee FI.

It is another advantage that the payment request does not need to be from a merchant or any business account holder. As a result, the payment can be between any two entities with an account with an FI including person-to-person (P2P) payments. Therefore, more users can use this system for more payments between users than with existing systems.

It is a further advantage that the account information and FI information does not need to be exchanged in order to enable the payer to confirm payment. The payee only needs to know the payer user identifier to request the payment from the payer. It is yet a further advantage that payment can be confirmed between the payee and payer without the payer having to register with the payer in advance in order to enable receipt of payment requests. It is yet another advantage that the payer can receive payment requests from multiple payees while only needing the one payee identifier.

It is yet another advantage that the payer responds to payment request sent by the payee and both, payer and payee are registered and authenticated with the central financial management system. As a result, the payer can be sure that the payment request does actually come from the payee and not from a malicious third person. Therefore, there is no need for complicated and expensive authorization procedures specific to confirm the payment.

Receiving from a payee or payee FI a payment request may comprise receiving the payment request from a sending party on behalf of the payee, the method comprises:

based on the payer identifier, automatically determining a payer FI and sending a payment request notification to the payee FI.

Step (a) may further comprise storing in computer storage a persistent object to represent the payment transaction having an associated status and storing an indication that the status is awaiting payment notification, and step (d) may further comprise updating the status by storing an indication that the status is confirmed.

Step (c) may further comprise storing in computer storage an indication that the payment can be settled and then:

(e) determining whether an indication is stored that the payment can be settled and if so initiating the settlement between the payer FI and the payee FI of the payment. Step (e) may further comprise initiating settlement of the multiple payments having an indication stored that the payment can be settled. Payment information may include a description of the payment.

Determining the payer FI may comprise using the payer identifier as a look up key in a computer storage that stores the payer FI associated with each of a plurality of payer identifiers.

The method may further comprise storing in computer storage associated with the payment request the determined payer FI and/or the payee FI.

Wherein step (d) may comprise automatically determining the payee FI based on the payment notification. Such as performing a lookup of the payer identifier for the associated payer FI or performing a lookup on a transaction identifier included in the payment notification for the associated payer FI as stored in computer storage.

In a second aspect there is provided software, that is, computer readable instructions recorded on computer readable media, that when executed by a computer causes the computer to perform the method described above.

In a third aspect there is provided a computer system of a central financial management service provider for facilitating a payment from a payer to a payee, the system comprising:

one or more communications ports; and

one or more processors to operate the communications port to:
(a) receive from a payee or a payee FI a payment request, the payment request including:
a payer identifier,
a payee identifier, and
payment information;
(b) based on the payer identifier, automatically determine a payer FI and sending a message including the payment request to the payer FI to cause the payer FI to notify the payer of the payment request and to enable the payer to confirm payment;
(c) receive from the payer FI a payment notification for the payment; and
(d) automatically determine the payee FI associated with the payment notification and send an output message including the payment notification to the payee FI.

In a fourth aspect there is provided a computer system for controlling a payment from a payer to a payee, the computer system comprising:
a persistence layer to store a status for the payment and user data including a user identifier and associated payer financial institution (FI);
a communication and mediation layer to receive an output message from a service layer, to send the output message to a recipient, to receive an input message from a sender, to validate the input message and to send the input message to the service layer; and
the service layer
   to receive the input message from the communication and mediation layer,
   where the input message includes a payment request, to determine a payer identifier, a payee identifier and payment information based on the payment request, to determine a payer FI based on the payer identifier and the user data in the persistence layer, to create the output message having the payer FI as recipient and including the payment request, that causes the payer FI to send to the payer a payment request notification that is associated with the payment, to send the output message to the communication and mediation layer and to set the status in the persistence layer to waiting for payment notification, and
   where the status is waiting for payment notification and the input message includes a payment notification associated with the payment, to determine the payee FI associated with the payment notification, to create the output message having the payee FI as recipient and including the payment notification, that causes the payee FI to send the payment notification to the payer, to send the output message to the communication and mediation layer.

In a further aspect there is provided a computer implemented method performed by a financial institution of a payee for facilitating a payment from a payer to the payee, the method comprising:

(a) generating a payment request message having:
a payer identifier,
a payee identifier, and
purchase information;

(b) sending a message including the payment request to a central financial management system (CFMS) to cause the CFMS to send to a financial institution of the customer (customer FI) a message including the payment request;

(c) receiving from the CFMS a message including confirmation of successful payment.

In another aspect there is provided software, that is, computer readable instructions recorded on computer readable media, that when executed by a computer causes the computer to perform the method described directly above.

In a further aspect there is a provided a computer system of a financial institution of a payee for facilitating a payment from a payer to the payee, the system comprising:

one or more communications ports; and

one or more processors to operate the communications port to:

(a) generate a payment request message having:
a payer identifier,
a payee identifier, and
purchase information;

(b) send a message including the payment request to a central financial management system (CFMS) to cause the CFMS to send to a financial institution of the customer (customer FI) a message including the payment request;

(c) receive from the CFMS a message including confirmation of successful payment.

In another aspect there is provided a computer implemented method performed by a financial institution of a payer for facilitating a payment from a payer to the payee, the method comprising:

(a) receiving from a central financial management system (CFMS) a payment request including:
a payer identifier,
a payee identifier, and
payment information;

(b) notifying the payer of the payment request that the payment request has been received and enabling the payer to confirm payment;

(c) receiving from the payer a payment confirmation; and

(d) sending to the CFMS a payment notification.

In yet another aspect there is provided software, that is, computer readable instructions recorded on computer readable media, that when executed by a computer causes the computer to perform the method described directly above.

In another aspect there is provided a computer system of a financial institution of a payee for facilitating a payment from a payer to a payee, the system comprising:

one or more communications ports; and

one or more processors to operate the communications port to:

(a) receive from a central financial management system (CFMS) a payment request including:
a payer identifier,
a payee identifier, and
payment information;

(b) notify the payer of the payment request that the payment request has been received and enabling the payer to confirm payment;

(c) receive from the payer a payment confirmation; and

(d) sending to the CFMS a payment notification.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 schematically illustrates financial grade information systems used in this example to support the payment;

FIG. 2 illustrates the method for facilitating a payment from a payer to a payee;

FIG. 3 further illustrates the method computer implemented method as performed by the central financial management system (CFMS);

FIG. 4 schematically shows the applications layers of the CFMS;

FIG. 5 schematically shows the state transitions of a state machine of the CFMS;

FIG. 6 illustrates the method of determining settlement details; and

FIG. 7 illustrates data on computer storage of the CFMS.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

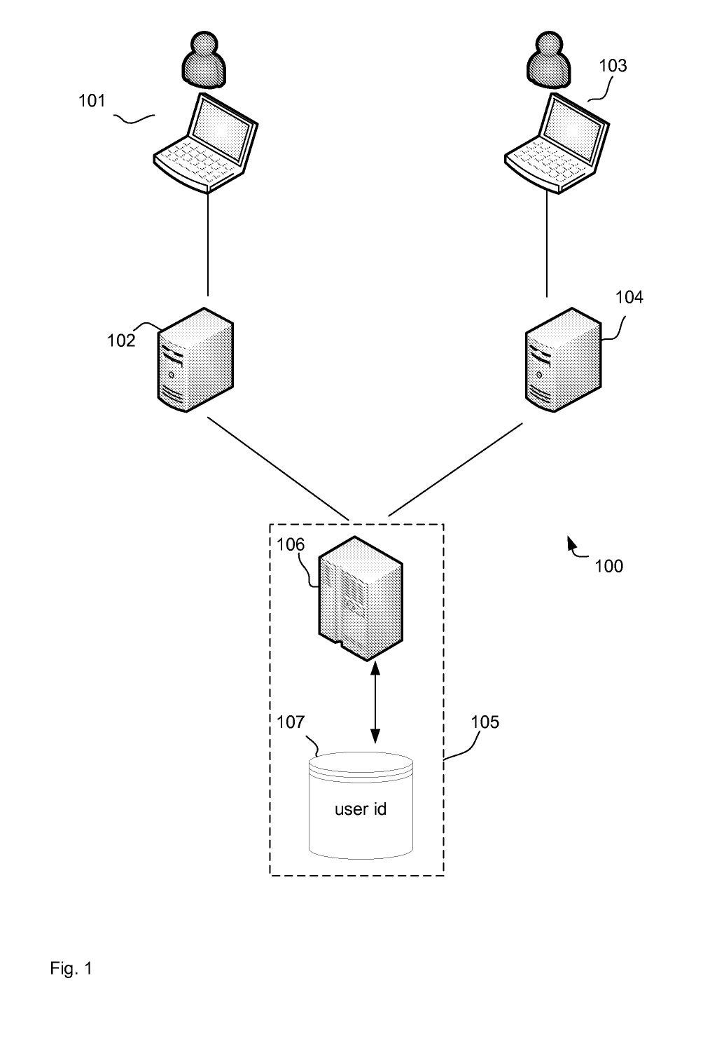

FIG. 1 illustrates a financial grade information system, such as an online payment system 100 comprising a payer 101 who has one or more accounts with a payer financial institution (FI) 102. The system also comprises a payee 103 who has one or more accounts with a payee FI 104. The payer 101 and the payee 103 have agreed that the payer 101 pays the payee 103 a certain amount of money. There are many different scenarios possible, such as the payer 101 and the payee 103 went to dinner together and want to share the cost that was originally paid in full by the payer 101 or the payer 101 wishes to buy something from the payee 103 and needs to pay for it. The payee 103 may be any entity that holds an account with a financial institution, such as a natural person, or a company, an online merchant or a restaurant. Typically the payer 101 would be a natural person but again can be any entity that holds an account with a financial institution.

Both the payer and payee are pre-registered with a central financial management system (CFMS) 105 to use this method.

The payment will be made from the payer's account at the payer FI 102 to the payee's account at the payee FI 104.

The computer systems of the payer FI 102 and/or the payee FI 104 are connected to the central financial management system (CFMS) 105 via communication I/O ports using the Internet or other wide area networks (WANs). As described further below, in this example messages sent to or from the I/O ports are comprised of data wrapped in Extended Marked-up Language (XML). Each message associated with the same payment request includes a unique transaction identifier allowing the different parties to associate subsequent messages received and sent relating to the particular payment transaction. For example, if the transaction is a payment, then a payment request and payment notification include the same transaction identifier.

The CFMS 105 also comprises one or more processors, that is a computer processing system such as a server 106 and a computer storage 107 such as non-volatile memory. The computer storage 107 stores for each payer or payee, the following information as appropriate:

user data for the payer 101 and payee 103, that is a unique user identifier and FI associated with the user identifier, display details, such as the name published with the user identifier, the user type (e.g. individual, business, government), official identification numbers (e.g. ABN, ACN), allowable usage information (e.g. accept real time notifications? payment requests? online transactions?), blocked list information, that is other user identifiers that are blocked from sending messages to this user identifier,limit information, minimum and maximum values that can be received or sent by the user identifier, transaction history, that is information of all transactions performed using the identifier stored by the CFMS as they occurred, other information associated with the identifier, such as auto pay rules and scheduled payment information.

The CFMS 105 also stores in the computer store 107 a payments file. This file includes information of payments that have been confirmed according to this method but actual funds transfer (settlement) between the payer FI 102 and the payee FI 104 has not yet occurred.

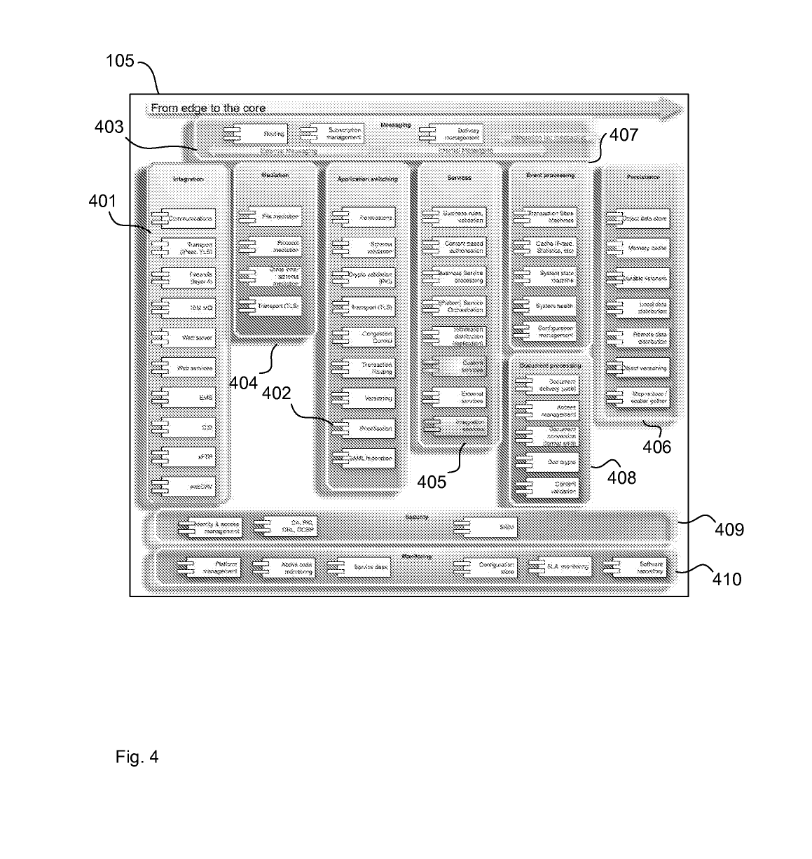

The CFMS 105 also has installed software that the sever executes to perform the method described here, which includes querying and updating the computer storage 107 and generating and sending messages to the payer FI 102 and payee FI 104 as appropriate. This is described in more detail further below in relation to FIG. 4.

The payer FI 102 also has computer storage (not shown) that stores for each payer identifier:

associated account information, such as account identification information and current balance

transaction information, including payments

allowable user information

method for communication of authorisation codes with the customer, such as SMS or email.

The payer FI 102 also has installed software that a processor executes to perform the method described here.

The payee FI 104 also has computer storage (not shown) that stores for each payee identifier:

associated account information, such as account identification information and current balance

transaction information, including received payments and outstanding payment requests

The payee FI 104 also has installed software that a processor executes to perform the method as described here.

For simplicity only one payer 101, payer FI 102, payee 103 and payee FI 104 are shown in FIG. 1, however it should be understood that in practice multiples of each entity each using one or more computer systems participate in this system 100. Also, in some cases the payer FI 102 and the payee F1 104 may be the same entity.

A person skilled in the art will readily appreciate the different ways the online banking facilities of FIs 102 and 104 can be accessed using a computer device, such as a personal computer or smart phone. Examples include through an internet browser, such as Microsoft Internet Explorer, Mozilla Firefox or Google Chrome, or a dedicated software application (software app) or smart phone application.

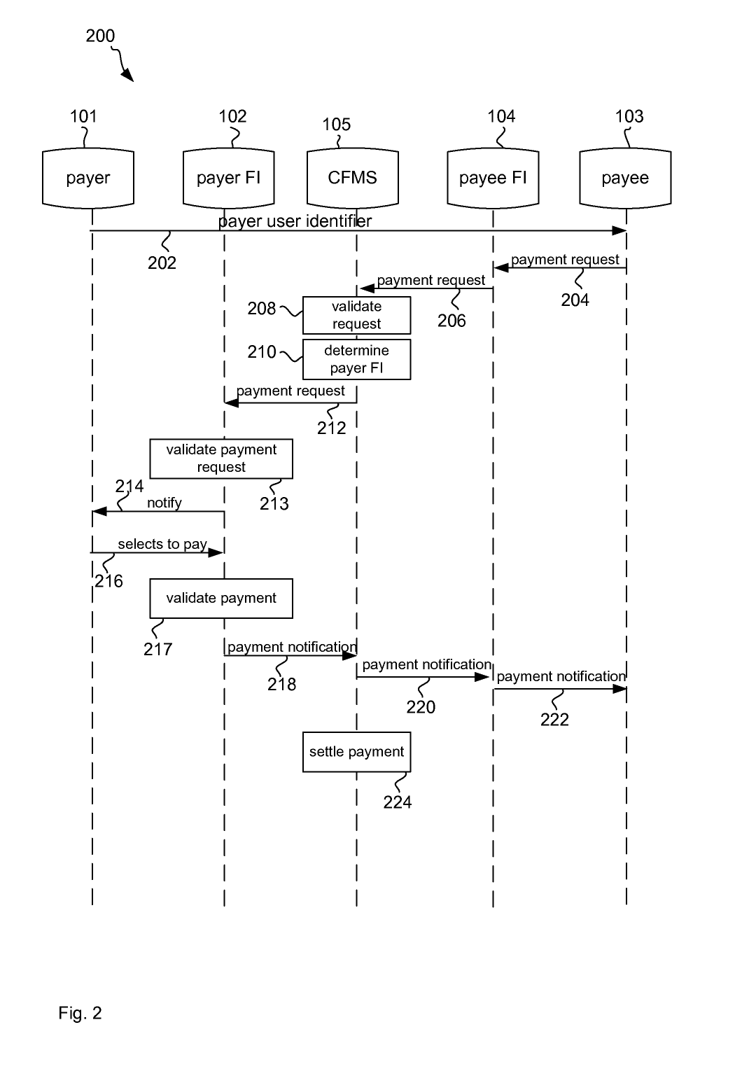

In this example, the payment between the payer FI 102 and the payee FI 104 is facilitated by the CFMS 105 such that the payee 103 receives a payment notification after a short time, such as 5 seconds. That is the document transfer is performed in real-time. The method of this example will now be described with reference to FIG. 2.

The payer 101 and the payee 103 agree on a payment from the payer 101 to the payee 103. The payer 101 then provides 202 a payer user identifier to the payee 103. This may be orally or by any other communication means such as SMS or email. A third person who intercepts the payer user identifier can not cause damage to any of the parties and therefore the payer user identifier, unlike a credit card number, does not need to be protected against eavesdropping.

A third party having obtained the payer user identifier can send payment requests to the payer. However, that third party must be registered with the CFMS first, and therefore, the sender of fraudulent payment requests can be easily determined and legal actions against that person can be undertaken.

Once the payee 103 knows the payer user identifier, the payee creates 204 a payment request. The payee 103 logs into the online banking facility of the payee FI 104 and enters the:

payer user identifier,

a payment amount and

a description, for example a customer reference, invoice number or “your share of dinner”.

The payment could have an expiry date (that is cannot be used to support payment in reply after this date) or due date (that is the date by which payment is due) in which case that is also entered. The payment request could be a once-payment, alternatively it could be re-occurring and the payee would then also need to enter the periodic information. The payee can also provide in the request an indication of whether payment of the payment request is limited to one payment of can be divided and made as multiple payments. The payee can also restrict the account type to be used and the amount paid—this includes a minimum, a maximum or an exact amount. The payee may apply flat rate and ad-volrem surcharging, differentiated by account type used to pay the payment request.

The payee may also attach a document, such as an invoice, to the payment request. The document may have an expiry date. According to the list of related documents above, we note that the co-pending PCT application also filed with the Australian Patent Office this day entitled “Transaction document storage” with Cardlink Services Limited also identified as the applicant discloses in more detail the methods, systems and software used to associate a document with a payment request.

The payment request could form part of a file of transactions sent by the payee (or another party on behalf of the payee) to the payee FI. The payment request can also be pre-validated before being sent.

The payee FI 104 verifies the payment request such as checking that the account associated with the payee FI has allowable usage to send payment requests, and the payment amount does not exceed the predetermined limit allowable for this payee or the payee FI using this method.

The payee FI 104 stores the payment request in the computer storage and generates and sends a message 206 including the payment request and a unique transaction identifier to the CFMS 105.

The CFMS 105 then receives the payment request and validates 208 the payment request. Validation of the payment request includes checking whether the payment request originates from the payee FI or whether there is fraud likely to be involved in the sending of the payment request.

It is noted here that the payee FI 104 has already authenticated the payee 103 by checking the password when logging into the online banking website. Therefore, the CFMS 105 only needs to check whether the payment request originated from the payee FI 104. There is no need for the CFMS 105 to authenticate the payee 104 again. In this example, checking whether the payment request originated from the payee FI 104 involves using a public key of the payee FI 104 to check a signature that was created using a private key of the payee FI 104 and attached to the payment request by the payee FI 104.

The CFMS then stores in the computer storage 107 a persistent object to represent this transaction and sets the status of the transaction to waiting for payment notification. More details of the processing of messages received by the CFMS is described in further detail below.

As mentioned above, both, the payer 101 and the payee 103 are registered with the CFMS 105. As a result, the CFMS holds a database of user identifiers and financial institutions associated with the user identifiers.

After validating 208 the payment request the CFMS 105 queries that database to determine 210 the payer FI 102 and display name based on the payer identifier that was included in the payment request. The CFMS 105 then sends 212 a message including the payment request, transaction identifier and the payee display name to the determined payer FI 102.

After receiving the payment request 212 from the CFMS 105 the payer FI 102 validates 213 the payment request by checking that the transaction limit is not exceeded, this transaction is in the allowable usage for the customer identifier and all other requirements are met. The payer FI 102 then notifies 214 the payer of the payment request with a payment request notification according to the payer's predetermined preferred methods of communication of these notifications and notified to the payer's bank. In one example, the payer FI 102 communicates the request notification to the payer 101 by email. In other examples, the payee FI 102 communicates the request notification to the payer 101 by SMS or simply by a payment notification facility on the online banking web site available to the payer next time they log into their online banking.

The payment request notification to the payer 101 includes the display name of the payee 103, the payment amount and the description. If the payee 103 has included a document into the payment request at step 204 the request notification includes a link to that document. Clicking the link causes a message to be sent to CFMS 105 by the payer FI 102 to determine the physical location of the document. Once the physical location of the document is determined, the payer browser is directed to that location to display or download the document. The document may be physically stored by the CFMS 105 or an authorised third party document storage host 108. Alternatively, the document may be stored on an external document storage provider and the CFMS 105 redirects the payer to the website of the document storage provider. According to the list of related documents above, we note that the co-pending PCT application also filed with the Australian Patent Office this day entitled “Transaction document storage” with Cardlink Services Limited also identified as the applicant discloses in more detail the methods, systems and software used to associate a document with a payment request.

The payment request notification also includes instructions on how to settle the payment request, such as a link or a button that the payer can click on 216 to confirm the requested payment. If the request notification was received by the payer 101 outside the online banking website, the payer first needs to log into the online banking website before the payment can be confirmed.

Alternatively, the payer 101 uses a smart phone to perform all the steps necessary to confirm the requested payment. A smart phone application may be installed on the smart phone to receive 214 a request notification from the payee FI 102, display to the payer 101 the payment details, provide to the payer 101 a clickable button to initiate the requested payment, and once the payer 101 has clicked on that button to send a message to the payer FI 102 that the payer wishes the requested payment to proceed. In one example, the payer 101 needs to provide a user identifier and password to the smart phone application for every payment. In another example the user remains authenticated over a longer period of time.

In this example, certain payment details are automatically populated from the payment request and the two messages are linked. The payer can change the details of the payment, such as the payment amount or the payment description. The payer may also attach a document, such as a remittance advice, to the payment to be sent to the payee. Again reference is made here to the co-pending PCT application entitled “Transaction document storage”. Of course, the payer can select to pay without making any changes to the payment data and therefore making this process a single click payment.

Once the payer 101 completes reviewing and updating the payment details and selects to pay 216, the payer FI 102 validates 217 the payment. This validation mainly involves checking whether the payer has enough funds available to settle the payment. The payer FI 102 also deducts the payment amount from the available funds to make sure that subsequent payments are checked against the reduced available funds even though the actual funds transfer may happen at a later time, such as over night or on the next banking day.

If everything is in order for the payment to proceed the payer FI 102 sends 218 a message including a payment notification and transaction identifier to the CFMS 105.

The payment notification is validated by the CFMS 105 and the status of the state machine for the transaction is changed to payment confirmed. The payment is then stored in the computer storage 107 an indication that the payment should be settled, such as storing the payment details in the payment file that will be settled across all FIs at the close of business that same day.

The CFMS 105 stores the transaction data, that is the data related to registering the document, in the data store such that a history of all transactions including registration of documents is available. The sender FI 104 can download the transaction history from the CFMS 105 and make the history available to the sender 103 without generating additional frequent traffic for the CFMS 105.

The CFMS 105 then sends 220 a message including the payment notification and transaction identifier to the payee FI 104. As described above, in this example the CFMS authenticates the payer FI 102 and not the payer 101 itself. In one example, the messages 206, 212 and 218 include the payee FI 104 and therefore, the CFMS 105 can determine the payee FI simply from the data in the message 218. In a different example, the messages 206, 212 and 218 include the payee user identifier. In that case the CFMS queries the database 107 to determine the payee FI after receiving the payment notification. Although in this example there is another database lookup required, the process is more robust against inconsistencies due to changing FIs.

If the payment request remains unconfirmed by the payer 101 for an extended period of time, the payee 103 may change financial institutions during that time. When the payee 103 changes FIs, the database in the CFMS 105 is updated but it is complicated and error prone to update the data in all pending payment requests. Therefore, it is advantageous to query the database of the CFMS to determine the payee FI since the payment notification can then be sent to the changed payee FI.

The payee FI 104 adds the payment amount as uncleared funds to the payee's account and forwards the payment notification 222 to the payee 103. As above, the payee FI 104 can communicate this notification by email, SMS or online banking website. Subject to the responsiveness of the payer 101, the time between the payee 103 creating 204 the payment request and confirmation 222 of the payment can be short time, such as 1 minute.

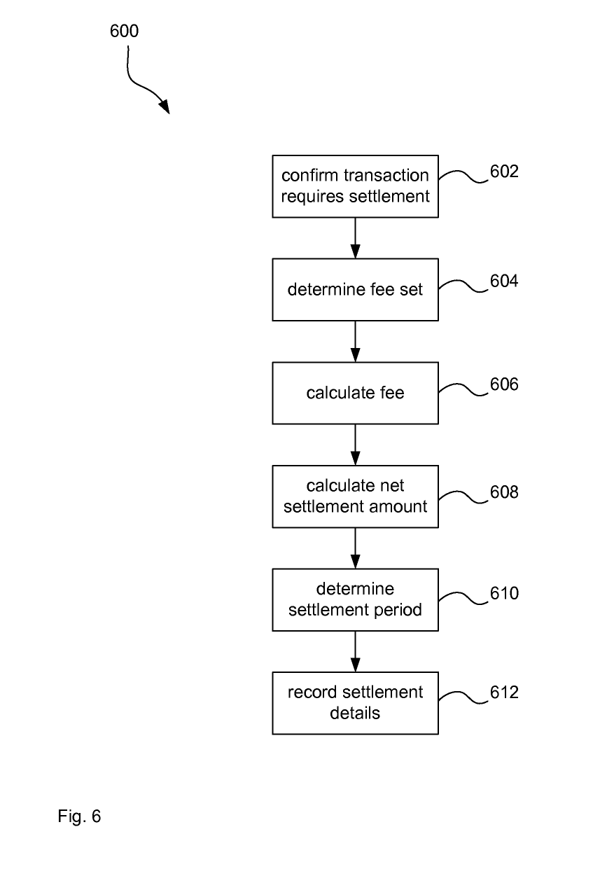

Nevertheless, the CFMS 105 initiates settlement, in this case the CFMS 105 performs 224 the actual settlement at a later time such as overnight or at the next banking day. It is noted that since the available funds of the payer 101 are checked before the payment is confirmed and the payer is authenticated and cannot dispute the transaction the risk of charge backs is smaller than when using other payment systems. Further details of settlement are described with reference to FIG. 6.

Alternatives to the method described above will now be described.

Less Communication with the Payee FI

In one form, the payee may communicate directly with the CFMS 105 and vice versa rather than through the payee FI. In this form, the payee FI has no involvement with the payment other than to receive a payment notification confirmation message from the CFMS or the payee FI so as to apply the payment information to account of the payee associated with the payee identifier. This alternative is attractive to payees that issue large number of payment requests. Typically, the payment requests will be sent by an authorised third party to the CFMS 105 on behalf of the payee that specialises in sending out payment requests in bulk and is authorised by the payee and CFMS to do so. The CFMS determines the payer and payee FIs based on the payee and payer Ids. The CFMS, then, sends a payment request to the payee FI and also a notification to the payer FI.

Less Communication with the Payee FI but Payee FI with Right of Veto

In another form, the communication with the payee FI is reduced as described directly above but the payee FI has the right of veto—that is, the payee FI may wish to validate the payment request before it is processed further by the CFMS.

In this form, the CFMS determines whether the payee FI has requested a right of veto when the CFMS receives the payment request message 204 directly from the payee.

If the payee FI has requested a right of veto then the CFMS sends the required message to the payee FI who then performs validation checks, such as fraud checks, and then sends a message back to the CFMS. In this case the CFMS does not perform any further steps unless the reply message indicates the validation by the payee FI was successful.

If the payee FI has not requested a right of veto a notification message is simply sent to the payee FI.

Payment Receipt Number

The payee may include on the payment request 204 a field called end-to-end transaction identifier. This is included in all subsequent messages sent for a transaction and accordingly stored by CFMS, payee FI, the payer FI and where appropriate the payee for future reference. This is in addition to the standard transaction identifier discussed above. This end-to-end transaction identifier can then be in both the relevant transaction records of the payee and payer. The end-to-end transaction identifier is used by the payee to associate and identify the transaction with an internal system such as accounting or inventory management system. The end-to-end transaction identifier is typically generated by these systems.

The payee can include the offer of a receipt which the payer can accept when making a payment.

Failure

If any validation fail, that entity can cause the method described above to stop and the appropriate failure messages to be sent.

Cancellation

If the payment request has not been paid, the payee can cause the payment request to be cancelled and the payer via the CFMS and in turn the Payer FI is notified of this.

Unsolicited Payment

For completeness, it is noted that a payment could be made, that is not in response to a payment request. In that case the payer would need to enter all details of the payment.

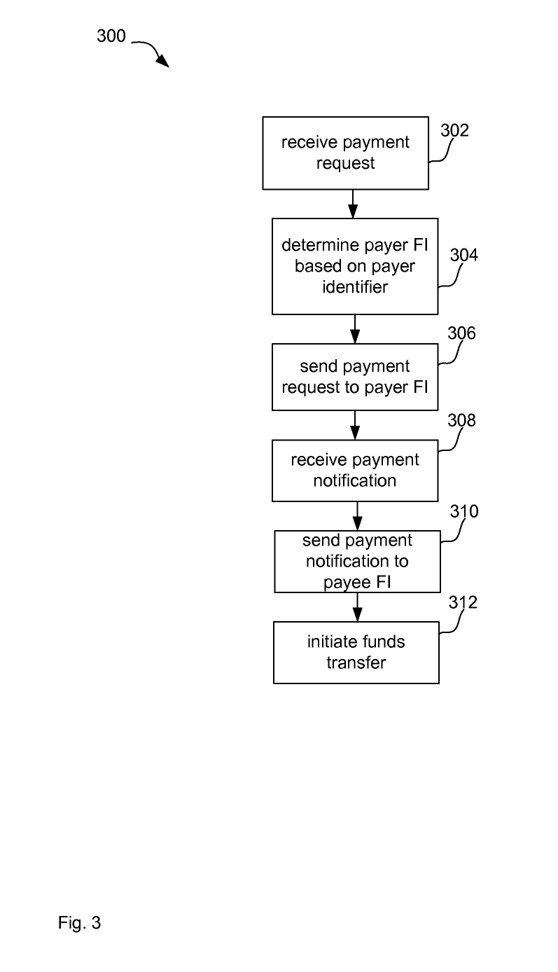

FIG. 3 illustrates as a flow diagram 300 the steps performed by the CFMS in facilitating a payment as described above in relation to FIG. 2.

FIG. 4 illustrates the CFMS 105 in more detail in form of an application layer decomposition by functionality. One of the layers comprised by the CFMS 105 is an integration layer 401. This layer is the application gateway into the CFMS 105. In the OSI stack this translates into all communication from layers 4 to 7. This includes name services (DNS), including proximity and topology based DNS resolution of system resources for the clients. This is achieved by the global traffic manager (GTM) functionality of the F5 Big-IP platform. Resource based load balancing is implemented within the CFMS 105, where incoming connection requests are directed to the application host. This redirection can be based on application specific service matrix, including, sticky, round-robin or least count etc.

This layer allows to better manage the resources as well as, in event of an application node failure, it also allows to seamlessly re-direct the request to surviving application nodes. The integration layer 401 also comprises IBM MQ Services, including Queue management, routing, recovery, redundancy of traffic using IBM MQ application.

The CFMS hosts its own queue manager framework. The queue manager provides the low level technical ack, nack and time-outs functionality. Web services, for synchronous communication are also integrated into the integration layer 401. Web services are screened for security issues using the Application Security Manager (ASM) from the F5 Big-IP product modules. The integration layer 401 further comprises web servers for all web requests for document retrieval as well as file upload, download for bulk file integration using Web-based Distributed Authoring and Versioning (WebDAV) method. Connect:Direct and Secure Shell File Transfer Protocol (sFTP) is used for the file transfers. All file transfers are managed from network file shares. The file mediation services in the mediation layer make use of the file system events to initiate the file processing. This is more efficient then polling a file system.

CFMS 105 further comprises an application switching layer 402 performing the functionalities of content based routing, message validation services and Security Assertion Markup Language (SAML) federation.

The application switching layer routes messages based on “affinity” where functions are stateful, such as complex event processing functions. For example, a transaction involving two other parties should be processed at a single service tier. However, messages from participants may be delivered to via any data centres of the CFMS or components within the data centres.

In the distributed CFMS, a message related to a payment may be received by a location or stack not processing the specific payment. The application switching layer 402 will identify the correct processing stack and route the message over. The routes of the messages are based on version of the schema used.

The application switching layer 402 prioritises messages based on importance of a message at a business layer, such as a block address request as part of fraud management.

The application switching layer 402 provides message validation services for confidentiality and assurance (decryption, encryption, signing, signature validation), access control (permissions and roles), technical validations (e.g., XML wellformedness) and business validations (higher level validations, if any) and SAML federation. This is used for processing document retrieval requests received by the CFMS 105. It involves validation of the assertion, invoking request to the back-end services and coordination of the response including additional SAML assertions to the caller.

CFMS 105 also comprises a messaging layer 403. The messaging layer 403 is a distributed high speed messaging tier that allows for very low latency and asynchronous message exchange in a reliable fashion. In line with the N+1 design principles, the messaging grid will autonomously recover from component failures. Each messaging server has a warm standby which allows for near instantaneous and stateful recovery with zero data loss. The messaging functionality includes queue, topics and subject based communication as well as integration with presence—for example based on Extensible Messaging and Presence Protocol (XMPP) or Remote Authentication Dial In User Service (RADIUS) events for end-point detection for transmission. The messaging functionality also includes message routing within and across the stacks and message level priority management and congestion control.

Three distinct messaging layers operate across the CFMS 105: external messaging, internal messaging and integration messaging. These layers are based on three distinct security zones. There is an additional messaging service used by the monitoring services.

Each messaging layer is to support the application services hosted at that tier and typically align with the security zones. There is no message routing crossing the security zone. All messages crossing the security zones will always go through a mediation layer 404.

Mediation layer 404 comprises message transformation services to transform messages from external to internal or vice-versa or from external to external. The mediation layer 404 also comprises orchestration functionality for integration with the core of the CFMS 105, detection of duplicates, stripping of documents and integration of document processing, bulk file iteration and response collator integration.

An internal facing mediation tier provides integration with settlement engine, which includes real time messaging integration for continuous streaming of information as the transactions take place and once a day files processing such as updates to Biller Master File (BMF). The internal facing mediation tier also provides integration with an Ops Portal that also includes file transport functionality where members can submit instructions by Bulk file and collect responses to the bulk files submitted by them. The internal facing mediation tier further provides billing and business intelligence.

CFMS 105 further comprises a service layer 405. This layer is where bulk of service functions are orchestrated based on the needs of various patterns. The services also include functionality for error correction, capturing errors and compensating actions. Some of the service functions will be bespoke to meet specific requirements. These include creation of the user identifier, transaction reference, universally unique identifier (UUID) generation with site affinities, etc. The services are hosted within the enterprise service bus (ESB) and communicate using messaging layer. The service layer is stateless while orchestrations are stateful. Complex event processing systems are used to manage and maintain the states as well as the state transformation machines.

One of the key functions hosted out of the services layer is integration with a persistence layer 406. The persistence 406 is provided by a Data Grid. The data access is abstracted at the service bus. The data access functions facilitate replication of data across all data grids where replication is addressed as part of the business transaction. This allows provisioning of additional system capacity in a near linear scalable fashion. Additional capacity can also be provisioned on demand. This design approach also allows for quick re-purposing of capacity for other functions. For example, the document rendering/processing capacity could be increased during end of the financial year period for capacity and service level management.

The CFMS 105 will have several service buses to meet requirements in different security zones:

a) External Demilitarized Zone (DMZ), to allow for functions such as duplicate transaction detection, enforcement of allowable usage types, and address allocation maps.

b) Document processing, to allow for all orchestration to process, store and retrieve documents. There are a few integrations with bespoke code, and appliances.

c) Internal, will include all other technical services. The internal services includes where orchestrations span stacks and/or sites. Orchestration across stacks, sites may be used where replication is part of business transaction.

Another layer within the CFMS 105 is an events processing layer 407 which is the control tier of the CFMS applications. One of the core functions that this application layer provides is managing and maintaining transaction states. This is achieved by state-transition-machines. State machines are defined for each transaction flows. It is the state machine that orchestrates the transactions provides event correlation with the other components of the CFMS 105 such as document processing provides the time-based event processing for TTRs.

The state machines are typically initialized by the first message/event in a transaction or instruction received by the CFMS 105—in this case a payment request 206. A transaction identifier is created, a state machine is created that is associated with the transaction identifier Subsequent processing and functions performed on the transaction result in events being generated. These events are relayed back to the state machine and based on the event it undergoes state changes. Once a transaction is complete and committed-in this case the payment is written to the payments file, the state machine is destroyed.

The event processing engine is also used for real-time collection of intelligence, such as fraud and statistical data generation for the user identifier. These statistics are kept hot and up to date as transactions are processed.

As mentioned above, the persistence is achieved by a data grid which is coordinated by a persistence layer 406. Geographic reach of the data grid together with a data grid provide internal replication in real-time to both the intra and inter grid members. The data grid will be built to provide a deterministic N+1 or better redundancy. This will allow the data grid to autonomously recover from component failures, sacrificing neither the data quality nor the data reliability. Persistence applies to entities that need to be persisted and entities that need to be accessible for all of above to work.

The CFMS 105 applies a shared nothing architecture. In order to achieve higher resilience and availability, non-blocking and near linear performance scalability, the data grid nodes will make use of direct attached storage. This also removes any single points of contention and single points of failure from the persistence tiers. This also reduces complexity in design by removing the need for Storage Area Network (SAN).

The data within the CFMS 105 needs to be consistent across all data centres. This requires data to be distributed as the data changes as part of various transaction flows. Within a transaction flows there are pre-defined commit points where recoverability and consistency needs to be provided. For example, at some key points the system needs to provide that data is also at the other data centre. These two points need to be synchronous. However, all other replication and data distribution within this transaction flow can be asynchronous.

The CFMS 105 further comprises a document processing layer 408. The CFMS 105 will be processing documents included as attachments, such as payment requests or payment confirmations. This is for use where a document or uniform resource locator (URL) or uniform resource identifier (URI) is attached to the message.

The CFMS 105 further comprises a security layer 409. The security layer 409 performs identity and access management employing a multi-factor authentication subsystem, a Certification Authority (CA) component and a role based access control subsystem. The multi-factor authentication subsystem provides strong authentication and integration with the federation components for admin and operator authentication and access control. The CA component provides X.509 certificate provisioning and management facility. The CA also provides a Certificate Revocation List (CRL) and Online Certificate Status Protocol (OCSP) services to ascertain validity/currency of X.509 certificates as part of the mutual authentication flow. The role based access control sub system will link identity to entity and their roles and access rights.

The security layer 409 also performs Security Incident and Events Management (SIEM), exception handling and management. To perform these tasks the security layer 409 employs logging components and correlation engines. The logging components provide a centralised facility to log all the messages and events, including network devices, security devices and services. This information can be used to debug and trace events and correlations between various events. The correlation engines are used to identify related events, patterns for security and other compliance escalations.

The security layer 409 also performs operational monitoring and maintenance, such as vulnerability assessment including intrusion detection and internal and external vulnerability scanning.

Further, the CFMS 105 comprises a monitoring layer 410. As part of the handover to Technology Operations and production readiness five scenarios will be tested to meet the integrity and recoverability targets:

deep polling and synthetic transactions;

split-brain;

recovery;

cold boot; and

application maintenance and upgrades.

Split-brain can happen if one data centre hosting the CFMS 105 loses visibility to the other data centre and as a result islands itself. This may force each data centre to autonomously infer that it is the last surviving node and the other node is down. Automatic detection of split-brain using third party quorum, majority detection which would result in one of the two data centres to be taken down as active to pending consistency status.

The layering of applications within the CFMS 105 in this form allows for seamless horizontal and vertical scalability by bolstering components at each layer as required. This specific design also assists in managing performance and service levels and helps in limiting the impact of changes which will be required during the lifecycle of the CFMS 105. As a result, the overall maintainability, scalability and in turn availability of the CFMS 105 is improved. For example, introduction of messaging based on the Advanced Message Queuing Protocol (AMQP) will only require additions to the integration layer 401 and mediation layer 404.

An example of using the application layers of the CFMS 105 will now be described. The payment request 206 in FIG. 2, arrives at the CFMS 105 as an encrypted Extensible Markup Language (XML) message. The message is received by a web service of the integration layer 401. In other examples, the message is received via an encrypted channel, such as IPsec, between the payee FI 104 and the CFMS 105. The integration layer 401 sends a transport level acknowledgment to the payee FI 104.

The message is handed over to the mediation layer 404, which converts the message from the outside schema to an inner schema. The mediation layer 404 converts messages from various different protocols into the same inner schema. Now that the message is in a suitable format for internal layers, it is forwarded to the application switching layer 402. The application switching layer 402 validates the encryption of the message including the validity of the key and routes the message to the appropriate module of the services layer 405.

In a different example, the integration layer, mediation layer and application switching layer are combined into a communication and mediation layer. This communication and mediation layer may act as in input and then receives an input message from an external sender, validates the input message and sends the input message to the internal service layer 405. This communication and mediation layer may also act as an output and receive an output message from the internal service layer 405 and send the output message to an external receiver.

The services layer 405 orchestrates the communication pattern that is necessary for completing the online payment process. As mentioned above, the service layer 405 is stateless and therefore, the services layer 405 instructs the events processing layer 407 to initialize a state machine according to a predefined communication pattern. This state machine information needs to be persistently stored in the persistence layer 406 even in the event of a failure of an entire data centre, such as in case of a natural disaster. Therefore, at this stage, the state machine information is duplicated to a second data centre in sufficient geographical distance from the first data centre. The further processing of the request needs to wait for the completion of the storing at the second data centre.

When a payment request is first received 206 by the CFMS 105 the state machine is initialized and made durable in the persistence layer 406 and the services layer 405 can query the state machine for the next step. In this case, the next step is to validate 208 the payment request and determine 210 the payer FI. Then, the service layer 405 generates a message including the payment request for the payer FI 102. This message passes through the application switching layer 402, the mediation layer 404 and the integration layer 401. The message is then sent to the payer FI 102. This starts a timer to detect a time out of the response of the payer FI 102. After technical validation by the payer FI 102, the integration layer 401 receives a response message acknowledging the correct transmittal of the payment request. This acknowledgement is passed to the mediation layer 404 to further monitor the responsiveness of the payer FI 102.

Once the payer FI 102 generates a confirmation and sends it to the CFMS 105, the confirmation is received by the integration layer 401 and passes through the mediation layer 404 and the application switching layer 402 to the services layer 405. Receiving the confirmation prompts the services layer 405 to advance the state of the state machine stored in the persistence layer 406 to the next state. As mentioned previously, the state of the state machine needs to be persistent and therefore, the duplication of the state change to a second data centre is again necessary.

When the payer FI 102 sends 218 a payment notification the receiving 218 and sending 220 of the payment notification by the CFMS 105 follows a similar scheme as the three party scheme described above.

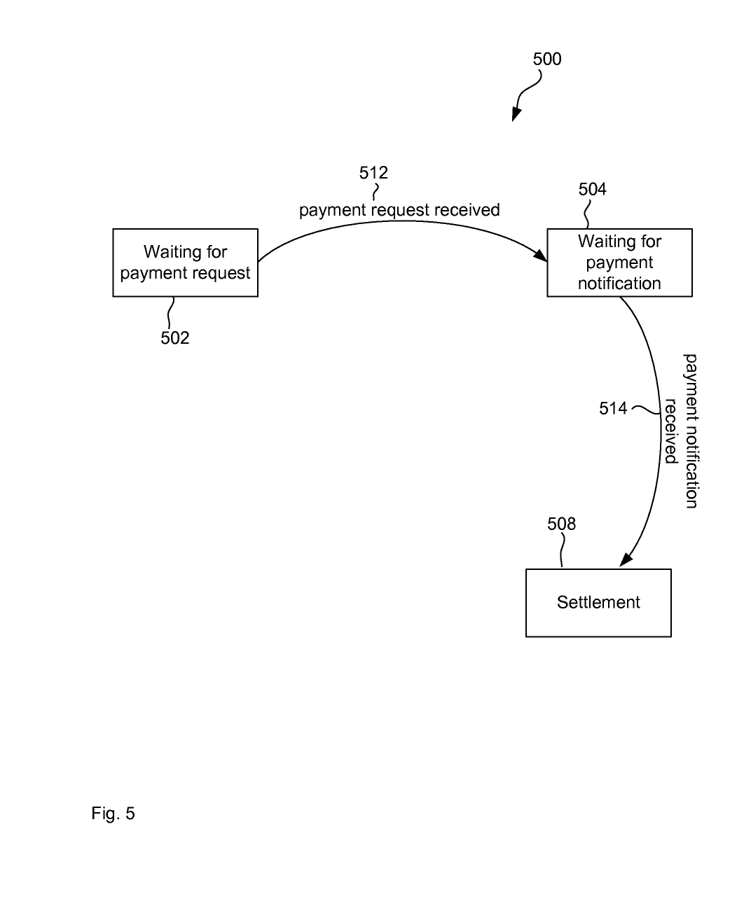

FIG. 5 illustrates a state transition diagram 500 for the state machine stored in the persistence layer. Payment requests, and payment notifications are associated with a specific payment transaction using a transaction identifier as described above. In turn, each payment transaction is associated with one state machine. As a result, when receiving a message related to a specific transaction, such as the payment request 206 and the related payment notification 218, the service layer can access the state machine and the current state stored in the persistence layer 406 for that transaction.

The state transition diagram 500 comprises three states, waiting for payment request 502, waiting for payment notification 504 and settlement/confirmed 508.

After initialization the current state of the state machine is waiting for payment request 502. In a different example, the state machine is not initialized before a payment request is received. As a result, the state of wait for payment request is not required in that example.

The communication and mediation layer as described above receives an input message from a sender, validates the input message and sends the input message to the service layer 405. Examples of validation are described above.

In a first case, the input message is a payment request. In this case the service layer 405 determines a payer identifier, a payee identifier and payment information based on the input message. With this information the service layer looks up the payer FI in the persistence layer 406 in FIG. 4. The service layer 405 also creates an output message that includes the payment request and sets as the recipient the payer FI. This output message including the payment request causes the payer FI to send to the payer a payment request notification that is associated with the payment. The service layer 406 sends the output message to the communication and mediation layer and creates a state machine associated with the transaction identifier from the message. The predetermined state transition logic present in the state machine causes the current state stored in the persistence layer 406 to be advanced 512 to waiting for payment notification 504.

In a second case, the input message is a payment notification and includes payment information as provided by the payer to the payee and the current state of the state machine associated with the transaction identifier from the message is waiting for payment notification 504. In this case the service layer 405 determines the payee FI and creates an output message having the payee FI as recipient. This output message including the payment notification causes the payee FI to process the payment notification. The service layer 405 then sends the output message to the communication and mediation layer. The predetermined state transition logic present in the state machine causes the current state stored in the persistence layer 406 to be advanced 514 to settlement/confirmed 508.

FIG. 6 illustrates a method 600 for creating settlement details. The method 600 commences by confirming 602 that the transaction requires settlement. The confirmation 602 comprises determining a transaction type, a transaction pattern and the number of parties involved in the transaction pattern. If the number of parties involved is 3 or more (i.e. the payer FI, CFMS and payee FI where the payer FI and payee FI are different FIs) the method continues with the next step, otherwise settlement is not required and method 600 terminates since the payer and payee FI are the same FI.

The next step of method 600 is to determine 604 an appropriate interbank fee set. This step comprises determining the payee FI and the payer FI, determining whether there is a set of interbank fees for this pair of FIs and if yes using the specific set of interbank fees. If no set of interbank fees can be found for this pair of FIs, a predetermined default set of interbank fees is used.

After determining the set of interbank fees, the method then calculates 606 the interbank fee and fee direction. For that, the method determines the characteristics of the transaction relevant to settlement, that is transaction type, fee basis for each user identifier, transaction attachments, and payment amount. From the appropriate set of interbank fees the method also matches the transaction characteristics with the interbank fee characteristic. If a match is found, the transaction interbank fee is calculated as:

a flat fee(if stated)+the fee rate in percent*payment amount.

The calculated fee may then be corrected by applying a minimum and maximum interbank fee. Finally, the fee direction as read from the set of interbank fees.

With the calculated fee the net settlement amount is then calculated 608. This is achieved by either adding to or subtracting from the payment amount the calculated fee depending on the fee direction.

The method then determines 610 the settlement period details. This step comprises based on a timestamp of the committed transaction determining the next closing date and time for settlement and identifying an associated settlement period ID and banking business day.

The last step of method 600 is to record 612 the settlement details. The recorded data comprises in this example:

transaction amount;

interbank fee amount and non-GST settlement amount determined in step 606;

the user identifier of the payer;

the user identifier of the payee;

settlement period details determined in step 610;

transaction type;

fee basis and version number of the payer user identifier; and

fee basis and version number of the payee user identifier.

Before the transaction details are recorded in a settlement record table, this table is updated. Then it is determined whether there is an entry in the table that matches the settlement period ID, closing date and time of the settlement period, banking business day, payer user identifier, payee user identifier, source account type, transaction type, attachment indicator, fee basis of the payer user identifier and fee basis of the payee user identifier. If no match is found, a new record is written to the settlement record table and a transaction count is incremented by 1.

After that the transfer amount, the interbank fee amount and the settlement amount are added to the respective base amounts. Then, a record is added to the settlement details table.

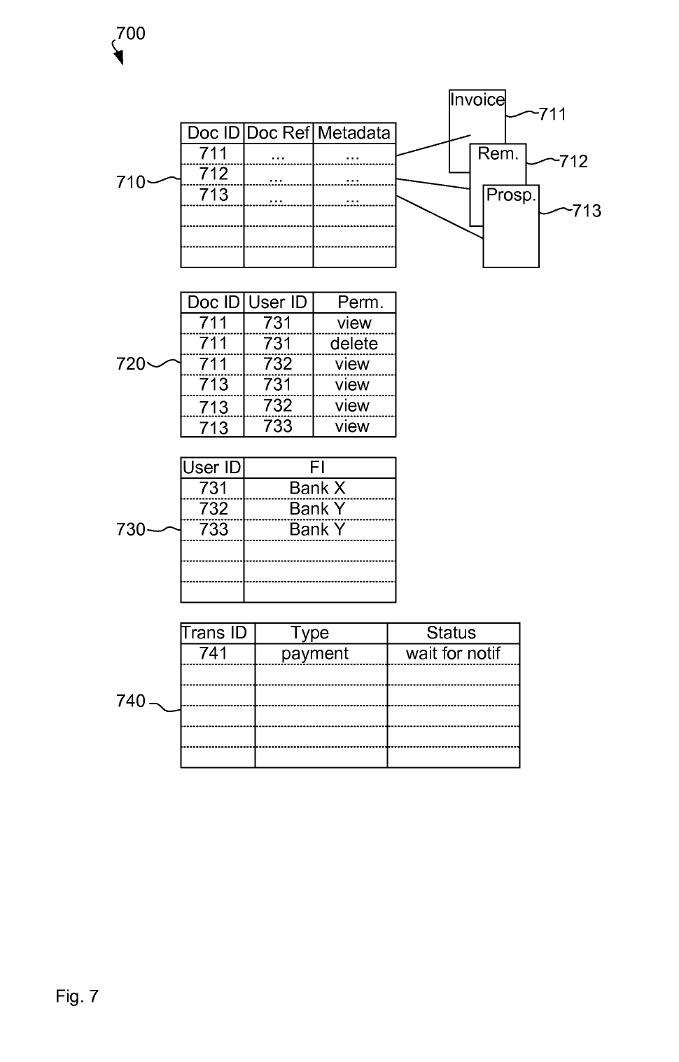

FIG. 7 illustrates data 700 on a data store comprising a document table 710, an access control table 720, a user data table 730 and a transaction data table 740. The tables are accessed by different layer from FIG. 4. For example, the document table 710 and access control table 720 are accessed by the document processing layer 408 while the transaction data table 740 is accessed by the event processing layer 407.

The document table 710 stores data related to documents registered with the CFMS 105. Each entry in the document table 710 stores the association between the document identifier, the document reference and the document metadata. When in use, the CFMS 105 accesses the document table 710 to store a new entry when a new document is registered. The CFMS 105 retrieves the document data and in particular the document reference when the document is requested. In this example, three document are registered, that is an invoice 711, a remittance advice 712 and a prospectus 713.

The access control table 720 stores information about which user has certain rights to certain documents. It is noted that one document identifier can have multiple entries in the access control table 720. In this example, a first user 731 has permission to view and delete document 711 while a second user 732 has permission to only view document 711. Typically, if document 711 is an invoice user 731 is the payee who has sent the invoice to user 732 who is the payer. The payee 731 can view and delete the invoice while the payer 732 can only view the invoice. Similarly, if the document 712 is a remittance advice, a payer can view and delete the remittance advice while the payee can only view the remittance advice. In contrast, the prospectus 713 may be sent to many different users and therefore the access control table stores many entries to grant permission to view the prospectus to many users.

Every time a document is attached to a transaction from a sender to a receiver, the CFMS 105 checks whether an entry already exists in the access control table and if not creates a new entry allowing the sender to view and delete the document and the receiver to view the document. The ability to delete, that is to recall a document by the sender is subject to certain controls. Not all documents can be recalled. A document can be recalled by the sender if an action involving a payment has not been yet made by the receiver. For example, if an invoice is attached to a payment request and the payer subsequently makes a payment against that payment request, the invoice can no longer be recalled by the sender.

The user data table 730 stores an association of the user identifier with an FI. In this example, user 731 has an account with bank X while users 732 and 733 have their accounts with bank Y. When a new user registers with the CFMS 105, the CFMS 105 creates a new entry in the user data table. When a sender sends any transaction to that user identifier as receiver, the CFMS 105 queries the user data table 730 to determine the FI of the receiver and sends the transaction to the receiver's FI.

The transaction data table 740 stores data related to transactions which are currently pending. In this example, transaction 741 is a payment request and the CFMS 105 is waiting for an payment notification from the payer FI. The CFMS 105 creates a new entry when the state machine is created. When the transaction is finished, such as by settling the payment, the entry in the transaction table 740 is deleted.

It should be understood that the techniques of the present disclosure might be implemented using a variety of technologies. For example, the methods described herein may be implemented by a series of computer executable instructions residing on a suitable computer readable medium. Suitable computer storage is readable media may include volatile (e.g. RAM) and/or non-volatile (e.g. ROM, disk) memory, carrier waves and transmission media. Example carrier waves may take the form of electrical, electromagnetic or optical signals conveying digital data streams along a local or wide area network or a publicly accessible network such as the internet.

It should also be understood that, unless specifically stated otherwise as apparent from the following discussion, it is appreciated that throughout the description, discussions utilizing terms such as “receiving”, “sending”, “processing” or “computing” or “calculating”, “optimizing” or “estimating” or “determining” or “displaying” or the like, refer to the action and processes of a computer system, or similar electronic computing device, that processes and transforms data represented as physical (electronic) quantities within the computer system's registers and memories into other data similarly represented as physical quantities within the computer system memories or registers or other such information storage, transmission or display devices.

It will be appreciated by persons skilled in the art that numerous variations and/or modifications may be made to the above-described forms, without departing from the broad general scope of the present disclosure. The present forms are, therefore, to be considered in all respects as illustrative and not restrictive.

What is claimed is:

1. A computer implemented method performed by a central financial management system for facilitating a payment from a payer to a payee, the method comprising:
(a) receiving from a payee or a payee FI a payment request, the payment request including:
a payer identifier,
a payee identifier, and
payment information;
(b) based on the payer identifier, automatically determining a payer FI and sending a message including the payment request to the payer FI to cause the payer FI to notify the payer of the payment request and to enable the payer to confirm payment;
(c) receiving from the payer FI a payment notification for the payment; and
(d) determining the payee FI associated with the payment notification and sending an output message including the payment notification to the payee FI.

2. The computer implemented method according to claim 1, wherein said receiving from the payee or payee FI the payment request comprises receiving the payment request from a sending party on behalf of the payee, the method comprises:
based on the payer identifier, automatically determining the payer FI and sending a payment request notification to the payee FI.

3. The computer implemented method according to claim 1, wherein the step (a) further comprises storing in a computer storage a persistent object to represent a payment transaction having an associated status and storing an indication that the associated status is awaiting the payment notification, and step (d) further comprises updating the associated status by storing an indication that the associated status is confirmed.

4. The computer implemented method according to claim 1, wherein step (c) further comprises storing in a computer storage an indication that the payment can be settled and then:
(e) determining whether an indication is stored that the payment can be settled and if so initiating a settlement between the payer FI and the payee FI of the payment.

5. The computer implemented method according to claim 4, wherein step (e) further comprises initiating a settlement of multiple payments having an indication stored that the payment can be settled.

6. The computer implemented method according to claim 1, wherein the payment information includes a description of the payment.

7. The computer implemented method according to claim 1, wherein said determining the payer FI comprises using the payer identifier as a look up key in a computer storage that stores the payer FI associated with each of a plurality of payer identifiers.

8. The computer implemented method according to claim 1, wherein the method further comprises storing in a computer storage associated with the payment request the determined payer FI and/or the payee FI.

9. The computer implemented method according to claim 1, wherein said step (d) comprises automatically determining the payee FI based on the payment notification.

10. A non-transitory computer readable medium with an executable program stored thereon that when executed causes a computer to perform the computer implemented method according to claim 1

11. A computer system of a central financial management service provider for facilitating a payment from a payer to a payee, the system comprising:
one or more communications ports; and
one or more processors to operate the communications port to:
(a) receive from a payee or a payee FI a payment request, the payment request including:
a payer identifier,
a payee identifier, and
payment information;
(b) based on the payer identifier, automatically determine a payer FI and sending a message including the payment request to the payer FI to cause the payer FI to notify the payer of the payment request and to enable the payer to confirm payment;
(c) receive from the payer FI a payment notification for the payment; and
(d) automatically determine the payee FI associated with the payment notification and send an output message including the payment notification to the payee FI.

12. A computer system for controlling a payment from a payer to a payee, the computer system comprising:
a persistence layer to store a status for the payment and user data including a user identifier and associated payer financial institution (FI);
a communication and mediation layer to receive an output message from a service layer, to send the output message to a recipient, to receive an input message from a sender, to validate the input message and to send the input message to the service layer; and
the service layer to receive the input message from the communication and mediation layer,
where the input message includes a payment request, to determine a payer identifier, a payee identifier and payment information based on the payment request, to determine a payer FI based on the payer identifier and the user data in the persistence layer, to create the output message having the payer FI as recipient and including the payment request, that causes the payer FI to send to the payer a payment request notification that is associated with the payment, to send the output message to the communication and mediation layer and to set the status in the persistence layer to wait for a payment notification, and
where the status is waiting for the payment notification and the input message includes the payment notification associated with the payment, to determine the payee FI associated with the payment notification, to create the output message having the payee FI as recipient and including the payment notification, that causes the payee FI to send the payment notification to the payer, to send the output message to the communication and mediation layer.

13. A computer implemented method performed by a financial institution of a payee for facilitating a payment from a payer to the payee, the method comprising:
(a) generating a payment request message having:
a payer identifier,
a payee identifier, and
purchase information;
(b) sending a message including the payment request to a central financial management system (CFMS) to cause the CFMS to send to a financial institution of a customer (customer FI) a message including the payment request;
(c) receiving from the CFMS a message including a confirmation of a successful payment.

14. A non-transitory computer readable medium with an executable program stored thereon that when executed causes a computer to perform the computer implemented method according to claim 13.

15. A computer system of a financial institution of a payee for facilitating a payment from a payer to the payee, the system comprising:
one or more communications ports; and
one or more processors to operate the communications ports to:
(a) generate a payment request message having:
a payer identifier,
a payee identifier, and
purchase information;
(b) send a message including the payment request to a central financial management system (CFMS) to cause the CFMS to send to a financial institution of a customer (customer FI) a message including the payment request;
(c) receive from the CFMS a message including a confirmation of a successful payment.

16. A computer implemented method performed by a financial institution of a payer for facilitating a payment from a payer to the payee, the method comprising:
(a) receiving from a central financial management system (CFMS) a payment request including:
a payer identifier,
a payee identifier, and
payment information;
(b) notifying the payer of the payment request that the payment request has been received and enabling the payer to confirm the payment;
(c) receiving from the payer a payment confirmation; and
(d) sending to the CFMS a payment notification.

17. A non-transitory computer readable medium with an executable program stored thereon that when executed causes a computer to perform the computer implemented method according to claim 16.

18. A computer system of a financial institution of a payee for facilitating a payment from a payer to a payee, the system comprising:
one or more communications ports; and
one or more processors to operate the communications ports to:
(a) receive from a central financial management system (CFMS) a payment request including:
a payer identifier,
a payee identifier, and
payment information;
(b) notify the payer of the payment request that the payment request has been received and enabling the payer to confirm the payment;
(c) receive from the payer a payment confirmation; and
(d) sending to the CFMS a payment notification.
